(19) United States
(12) Patent Application Publication
(10) Pub. No.: US 2007/0186281 A1
(43) Pub. Date: Aug. 9, 2007

(54) Securing network traffic using distributed key generation and dissemination over secure tunnels

(76) Inventor: Donald K. McAlister, Apex, NC (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/649,336

(22) Filed: Jan. 3, 2007

Related U.S. Application Data
(60) Provisional application No. 60/756,765, filed on Jan. 6, 2006.

(51) Int. Cl. G06F 15/16; G06F 17/00; G06F 9/00

(52) U.S. Cl. 726/14

(57) ABSTRACT

A technique for securing message traffic in a data network using a protocol such as IPsec, and more particularly various methods for distributing security keys where key generation, key distribution, policy generation and policy distribution are separated, with inner to outer header replication on packet traffic. The approach permits encrypted messages to travel seamlessly through various otherwise unsecured internetworking devices.

### RELATED APPLICATION

This application claims the benefit of U.S. Provisional Application No. 60/756,765, filed on Jan. 6, 2006. The entire teachings of the above referenced application are incorporated herein by reference.

### BACKGROUND OF THE INVENTION

The present invention relates to securing message traffic in a data network using a protocol such as IPsec, and relates more particularly to how security keys are distributed, with inner to outer header replication on packet traffic, so that secure packets may travel seamlessly through various otherwise unsecured internetworking device configurations.

The following definitions are used in this document:

“Securing” implies both encryption of data in transit as well as authenticating that the data has not been manipulated in transit.

A “secure tunnel” between two devices ensures that data passing between the devices is secure.

A “security policy” (or “policy”) defines data (or “traffic”) to be secured by a source IP address, a destination IP address, a port number, and/or a protocol. They also define the type of security to be performed.

A “key” for a secure tunnel is the secret information used to encrypt and decrypt (or to authenticate and to verify) data in one direction of traffic in the secure tunnel.

A “Management and Policy Server” (MAP) is a device that is used to define high level security policies, which it then distributes to one or more Key Authority Points (KAPs).

A “Key Authority Point” (KAP) is a device that generates detailed policies from high level policies, which it then distributes to Policy Enforcement Points (PEPs).

A “Policy Enforcement Point” (PEP) is a device or a function that secures data based on the policies.

Existing Network Security Technology

Computer network traffic is normally sent unsecured without encryption or strong authentication of the sender and receiver. This allows the traffic to be intercepted, inspected, modified, or redirected. Either the sender or receiver can falsify their identity. In order to allow private traffic to be sent in a secure manner, a number of security schemes have been proposed and are in use. Some are application dependent, as with a specific program performing password authentication, while others, such as TLS, are designed to provide comprehensive security to whole classes of traffic such as HTTP (Hyper-Text Transfer Protocol) and FTP (File Transfer Protocol).

IPsec was developed to address a broader security need. As the majority of network traffic today is over Internet Protocol (IP), IPsec was designed to provide encryption and authentication services to this traffic regardless of the application or transport protocol. This is done, in IPsec tunnel mode, by encrypting a data packet (if encryption is required), performing a secure hash (authentication) on the packet, and wrapping the resulting packet in a new IP packet indicating it has been secured using IPsec.

The secrets and other configurations required for this secure tunnel must be exchanged by the parties involved in order for IPsec to work. This is accomplished using Internet Key Exchange (IKE), which is done in two phases.

In a first phase (IKE Phase 1), a connection between two parties is started in the clear. Using public key cryptographic mechanisms, where two parties may agree on a secret key by exchanging public data without a third party being able to determine the key, each party may determine a secret for use in the negotiation. Public key cryptography requires that each party either share secret information (pre-shared key) or exchange public keys for which they retain a private matching key. This is normally done with certificates, e.g., Public Key Infrastructure (PKI). Either of these methods authenticates the identity of the peer to some degree.

Once a secret has been agreed upon in IKE Phase 1, a second phase (IKE Phase 2) may begin and the specific secret and cryptographic parameters of a specific tunnel are developed. All traffic in IKE Phase 2 negotiations is encrypted by the secret from IKE Phase 1. When these negotiations are complete, a set of secrets and parameters for security have been agreed upon by the two parties and IPsec secured traffic may commence.

When a packet is detected at a Security Gateway (SGW) with a source/destination pair that requires IPsec protection, the secret and other security association (SA) information are determined based on the Security Policy Database (SPD) and IPsec encryption and authentication is performed. The packet is then directed to a SGW that can perform decryption. At the receiving SGW, the IPsec packet is detected, and its security parameters are determined by a Security Packet Index (SPI) in the outer header. This is associated with the SA, and the secrets are found for decryption and authentication. If the resulting packet matches the policy, it is forwarded to the original recipient.

### PROBLEMS WITH THE PRIOR ART

General Limitations of IPsec

Although IPsec tunnel mode has been used effectively in securing direct data links and small collections of gateways in networks, a number of practical limitations have acted as a barrier to more complete acceptance of IPsec as a primary security solution throughout the industry.

Configuration of Policies—Each SGW must be configured with each pair of source and destination IP addresses or subnets that must be secured (or allowed in the clear or dropped). For example, 11 SGW units fully meshed, each protecting 10 subnets, would require 1000 policies in the SPD. This is a challenge in terms of the user setting up the policies, the time required to load the policies, the memory and speed difficulties in implementing the policies, and the increase in network time spent performing negotiations and rekey. The time required for initial IKE negotiations in this example may exceed 10 minutes.

In addition, even smaller networks would require the user to have a complete knowledge of all protected subnets and their security requirements, and any additions or modifications would need to be implemented at each gateway.

Certificate/PKI Management—PKI can become complex and difficult to manage. At a minimum, it is intimidating to many network managers, however, strong PKI implementation is at the heart of effective security using IPsec (or TLS for that matter). The SGW should make this aspect as easy as possible for the network manager.

Multicast/Broadcast Traffic—IPsec in its present configuration cannot secure multicast or broadcast traffic. This is because keys are established between two entities and multicast or broadcast involves sending traffic from one source to many destinations at once. The IETF has a couple of RFCs in place or in process to address this (GDOI, GSAKMP), but they are addressed only to multicast and require the implementation of a multicast network to distribute keys, and are not yet generally available.

Load Balancing—Many large network implementations require load balancing or other Quality of Service (QOS) techniques where traffic to a particular address may take one of a number of paths. If a set of SGW units must be placed along these parallel paths, there may be no way to assure which SGW the traffic sees. As IKE provides secrets only between a pair of SGW units (remote and local), traffic to the second SGW would require a different set of secrets. This is not possible in existing IPsec implementations. The result is a limitation in the placement of SGW units in the network which may not be possible in certain situations.

Network Address Translation (NAT)—There are various forms of NAT, all of which cause problems for IPsec. With Static NAT, a source IP address on an outgoing packet is replaced with an assigned replacement IP address. If the SGW exists before the static NAT device, the original source IP address will still exist in the encrypted packet and will be exposed on decryption. This would likely create problems on the receiving network or on the return packet. Dynamic NAT (which is rarely used) is similar except that the replacement IP address comes from an available pool. In either case, the SGW must be placed outside the NAT device.

In masquerading dynamic NAT (NAPT), the source IP address of a packet is replaced with a new source IP address and the port number is changed to identify the original source IP address and port. This may be done to provide a single IP address to the wide area network (WAN) for a large number of IP addresses in the local area network (LAN).

Unfortunately, if the SGW is behind the NAT device, IPsec hides the port and IP address on the original packet and does not provide a port on the outer header. The NAPT protocol is broken without a port to modify. A mechanism called NAT-Traversal (NAT-T) had been added to IPsec to address this problem. This can also be addressed by placing the SGW outside the NAT devices, but normally cannot be done in cases of remote access by a home user running the IPsec gateway on his computer.

Further variations of NAT can be combined with load balancing, creating virtual servers or providing QOS which combines the problems of NAT with the load balancing problem described above.

Firewalls/Intrusion Detection Systems (IDS)—A firewall or IDS can create conflicts with IPsec as they may require inspection of the packet beyond the outer header (Layer 3). Firewall rules are often set to manage connections based on port or protocol, but this information is stored in the encrypted packet under IPsec. An IDS normally does deep packet inspection for viruses, worms, and other intrusion threats. Again, this information is encrypted under IPsec. Many firewall functions can be implemented using well written IPsec policies, although this can complicate the SPD entries. If the SGW is on the WAN side of the firewall and IDS, this problem is eliminated.

Path Maximum Transfer Unit (PMTU) and Fragmentation—The PMTU specifies the maximum IP packet size that can be sent, and above that size, packets must be fragmented to be sent in smaller packets. A protocol for PMTU discovery permits a device to send larger and larger packets with a “Do Not Fragment” bit set. This continues until a device with a path limitation sends back a message that the packet is too large. Other networks simply set the PMTU to a specific value.

In IPsec, however, the packet is made larger by the IPsec header information. If the devices behind the SGW uses the largest packet size, the SGW must either fragment the packet, which can be slow and certainly reduces network efficiency, or ignore the PMTU. To avoid this problem, networks must employ PMTU discovery or set the PMTU for devices behind the SGW smaller than for the main network.

Resilient Network Traffic—If the network is implementing resiliency, it will likely require that the secure solution be resilient as well. This can be accomplished with VRRP, but a switch-over would result in the need to rekey all traffic. In a fully meshed situation, this could be a significant interruption. If fast switch-over is required, a resilient gateway with shared state may be needed.

Challenges Specific to End-To-End Security

One of the most significant barriers to general acceptance of IPsec as a security solution is the challenge of securing data from where it leaves one computer to where it enters another computer. This desired level of security, combined with authentication and authorization on each side, would extend security from just covering the WAN (e.g., the Internet) to protecting data from unauthorized internal access.

Some of the general limitations of IPsec are exacerbated by end-to-end deployment. For example, the IPsec implementation cannot be placed on the WAN side of the firewall, IDS, NAT device, or any load balancing between virtual servers. There are a number of hurdles to true end-to-end security in addition to the general limitations described above.

Installation of an IPsec/IKE Stack on Individual PCs—With the variety of available operating systems (Windows XP, XP Service Pack 1 and 2, Linux and all of its kernel releases, etc.) and hardware platforms, a software implementation of the IPsec stack, which is dependent on both of these, must be designed, compiled, tested, and supported for each implementation. Hardware solutions, such as IPsec on a NIC, provide some separation from these issues, but preclude automated remote installation of the IPsec stack.

In addition, the computer with the installation must be configured with the user certificate and the policy configuration. Ideally, the user would be identified in some way other than a machine based certificate, but unfortunately, all existing implementations require the computer to be configured directly, normally by a network security manager. IKE also offers methods for remote access using certificate based authentication combined with RADIUS and XAUTH for the user ID as well as mode configuration to supply the user with a local network identification.

Limitation in Ability to Provide High-Speed, Low Latency, and High Number of SAs and Policies

A software solution on a computer (or mobile device) would be unable to provide high speed encryption or latency as low as on the existing SGW. In some cases this does not matter, but in situations with a high speed connection or involving streaming data, this may be significant. A hardware solution may suffer this limitation as well due to heat, space, or power considerations. Either solution may be limited in the number of SAs or policies that are supported, and could be critical in a large meshed security situation.

### SUMMARY OF THE INVENTION

A. Division of Security Policy Definition, Key Definition, and Their Distribution

Implementation of a SGW requires policy management, IKE key generation and exchange, and IPsec policy enforcement. By dividing these functions into separate components and combining them in new ways, one may solve some of the limitations of existing IPsec approaches and offer approaches to resolving other limitations as well. One approach proposed herein is the logical separation of IKE and IPsec functionality as follows:

Policy Enforcement Point (PEP)—This is a software module that executes in a SGW on the data path that performs packet encryption and decryption as well as IPsec header generation on packets requiring security. It also passes or drops packets and may be configured to perform additional functionality such as Static NAT or fragmentation. It is typically configured with security policies and SAs with SPIs, and keys for encrypting and decrypting inbound and outbound packets.

In addition to the IPsec functionality, certain additions to the capacity of the Policy Enforcement Point may provide further flexibility:
Maintaining the IP Header of the Outgoing Packet in the IPsec Outer Header—Copying the original source and destination IP address and MAC address of the encrypted packet provides flexibility in a number of situations. In multicast and broadcast, this information is necessary as the packet is copied to many locations, not just to a single gateway. In load sharing or resiliency, the packet may travel on different paths and via different PEP units. This may also allow existing network equipment to work with limited modifications in the presence of a gateway. This requires that the Policy Enforcement Point recognize the IPsec packets not addressed to it and handle them correctly. It also requires appropriate handling of ARP and other network traffic through the PEP.
Additional Services Such As Static NAT—If a SGW must be behind a device such as a Static NAT device, it may be necessary to move the functionality into the SGW.

Key Generation Layer—This module creates keys for a portion of security for a given tunnel. In IKE, this is done in coordination with a single peer as each side agrees on outbound and inbound keys. This may also be a single unit generating keys for traffic between a number of units, or may be a single SGW generating a key for outbound traffic on a given tunnel.

Key Distribution Layer—This module insures that all connections to a tunnel between SGWs have the keys necessary to encrypt and decrypt data between the endpoints. In IKE, this is done as part of the IKE Phase 2 key exchange between two peers. It could also be a unit sharing its keys with another unit, or a device sharing keys with a group of SGW units. It should be noted that the key distribution must be securely protected to prevent eavesdropping and tampering, and to assure that the key exchange is with an authorized party, either through IKE Phase 1 (as in standard IKE) or with an established IKE tunnel passing the keys under IKE Phase 2 (as with normally encrypted traffic.)

Local Policy Definition—This module maintains information on IP addresses, subnets, ports, and/or protocols protected by the SGW. This may be part of a complete policy definition, as provided to the system, or may be a single IP address on a remote access client. It could be a discovery process done by a SGW, or may be a collection of subnets protected by the SGW. If the complete policy definition is not present, it must include information to link the protected local traffic to its secure destinations.

Remote Policy Definition—This module maintains information on IP addresses, subnets, ports, and/or protocols that are remote to the protected region which require protection of traffic with the local region. Remote Policy Definitions are as with the local policy definition. This function may be locally defined or distributed throughout the network.

Policy Linkage—This module provides linkage of the Local and Remote Policy Definitions for a specific gateway. This may be automatic, as in the complete policy definition currently used, or it may be distributed across a network.

Policy Distribution—Once policy linkage has been made, the policy must be installed at the Policy Enforcement Point. This may be done at configuration or may be done as part of a discovery process as remote sites report their Remote Policy Definitions to a local Policy Linkage. This may also be done on a per packet basis as outgoing packets have a policy check performed with the results cached. Policy Distribution must be done securely under IKE Phase 1 or IKE Phase 2 protection to prevent tampering and to assure that the policy exchange is with an authorized party.

It should be noted that, in general, all traffic between the modules described above should be either local (within a single device) or protected by a secure tunnel. Each device should be managed via a secure tunnel and with secure user authentication. Additionally, if a highly resilient implementation is required, each module must be resilient and if state is stored, a method for exchanging state and performing switch-over be implemented.

B. Solution Using Distributed Policy and Key Generation, Shared Keying, and Secure Dissemination

Using the above separation of functionality, a number of different scenarios are possible that address various limitations of standard IKE/IPsec implementations. It should be noted that not all implementations may be implemented at the same time and each offers certain limitations or requirements, making the optimal choice a balance of factors.

Locally generated outbound keys shared with multiple peers—In a scenario where multiple identical paths may be used for traffic flow and each must be secured identically, one solution is to have the key(s) for each outbound flow be generated locally to the PEP. These outbound keys are then distributed over IKE tunnels, either directly to a set of similarly configured PEP peers, or indirectly via a common Key Authority Point (KAP).

In a typical configuration, the Policy Generation and Policy Distribution functions may exist on a single unit with the Key Distribution (a Policy Server/Key Distributor). This PS/KD is configured with the complete policy definition (local and remote) as well as the PEP units that it would manage. It may manage all PEP units in the network, local and remote.

Each PEP/Key Generator (running within a SGW) receives policy information and distributes and receives keys via the PS/KD. The PS/KD would be responsible for insuring each SGW is properly configured while each SGW would be responsible for initiating rekey for its outgoing keys.

This configuration provides a robust response to load balancing and resiliency while offering ease of management and simple state functionality in each unit. The limited state in units other than the SGW units makes it easy to provide resiliency. As the whole secure network state is distributed, there is no single point of attack for an intruder. As with all load balanced solutions, this approach may make little if any use of IPsec sequence numbers and may be more open to certain replay attacks. Scalability is conceptually good, but limited by the number of SA entries that is required at each SGW as each SGW produces a key for a given tunnel. This same approach could be used for multicast, providing improved security, but the scaling of keys could become prohibitive.

Outbound Keys, Local Distribution—In this approach, key generation for each tunnel is performed globally by a unit that also performs local and remote policy generation and linkage, e.g., Policy Server/Key Server (PS/KS.) These policies and SAs are then sent to all PEP units for use. The complete policy definition is loaded on the PS/KS for the complete network.

This approach may serve a load balancing, resilient network, and additionally, it would handle the multicast network without the scaling problem of separate keys from each PEP.

The PS/KS becomes a natural attack point for intruders trying to cripple or compromise a secure network as all keys are stored (or at least generated) there. Resiliency of the PS/KS is also a challenge due to its stored state. Still, this is a strong solution for complex networks, especially involving multicast.

Remotely Generated Keys Using IKE Shared Locally—If two network regions require a secure tunnel, but there are multiple PEP units on each side that feed the tunnel, a unit on each side could perform IKE between the two regions and then distribute the resulting policies and SAs to the local PEP units. This unit, a Virtual Gateway (VGW), may combine Local and Remote Policy Generation and Distribution, shared Key Generation (using IKE), and Key Distribution.

This approach offers a number of advantages. Many of the advantages of peer-to-peer IKE are maintained, such as shared development of secrets, while the problems such as load balancing are solved. This approach could be used with multiple low cost PEP units at each PS with the local policy limited to the individual PC's IP address. It may be possible to use this approach to generate a decrypt-encrypt barrier around devices that need to see a clear packet (such as a firewall or IDS). While this approach could be used for multicast, it would require multiple SAs for each multicast address if more than one peer network is involved.

This approach could be used on Remote Access or existing IKE/IPsec devices, either by spoofing the peer to send the IPsec packet to the original local IP address or using the VGW as a “secure router” for these packets (receiving them, changing the destination, and then resending them.)

The VGW may be a natural target of attack, but no more so than a gateway located at the edge of the WAN. Additionally, making the VGW resilient to failure without packet loss would be challenging as it contains as much state as a normal SGW.

C. IPsec Challenges Addressed by the Proposal

These approaches offer some degree of solution to many of the problems facing IKE/IPsec security:

Configuration of Policies—The distribution of local and remote policy definition combined with policy linkage provides simplified secure network definition. This is enhanced by the ability to load individual policies to the PEP as is implied in the above descriptions.

Certificate/PKI Management—Separation of functions adds to the certificate requirement. Any implementation of these approaches should include an effective, easy to manage, PKI system to be used with the secure network.

Multicast/Broadcast Traffic—All solutions using separate Key Distribution from IKE solve this problem, though some are more effective and scalable than others.

Load Balancing—All solutions using separate Key Distribution from IKE solve this problem, though some are more effective and scalable than others.

Network Address Translation (NAT)—Static NAT may be done on the PEP. Dynamic NAT can be done in IKE using mode configuration. NAPT may also be managed via NAT-T. Separate local and remote encryption may assist further.

Firewalls/Intrusion Detection Systems (IDS)—These may be surrounded with a decrypt/encrypt barrier to provide a clear packet to the firewall or IDS. This is best implemented with a configuration that performs key distribution to multiple PEPs.

Resilient Network Traffic—Many of these approaches improve secure network resiliency by providing multiple identically keyed paths and by providing low-state controllers for easy failover. Approaches with complex states in units other than the PEP will offer greater resiliency challenges.

Installation of an IPsec/IKE Stack on Individual PCs—By separating Policy and Key Generation and Distribution from the PEP, the requirements of a PC installation are greatly reduced.

Limitation in Ability to Provide High-Speed, Low Latency, and High Number of SAs and Policies—By limiting the IPsec stack on the node to the PEP and with a careful choice of approaches, the high number of SAs may be mitigated. Use of the local encrypt all with remote policy encryption may be useful here as well.

Key distribution for load balancing, multicast, etc.—As noted above, IPsec only allows key distribution from point to point. Thus, if having two PEPs at a single location is desirable, which may be the case for load balancing, resiliency, or backup purposes, standard IPsec key distribution protocols such as Internet Key Exchange (IKE) will not work. One could manually install keys in this situation in each of the endpoints, but this is cumbersome. Even if one manually installs keys, it does not avoid the problem with multicast messages; the standard IPsec tunnel mode packet formats encrypt the original source and destination addreses, making it impossible for internetworking equipment that may be between PEPs to correctly route multicast packets.

In a preferred embodiment, the invention is a method or an apparatus for securing message traffic in a data network using a security protocol, where at a Policy Enforcement Point (PEP) within a network of PEPs, a security policy definition to be applied to the traffic across the network is determined. The policy definition includes at least a definition of the traffic to be secured and parameters to be applied to the secured traffic. An outbound key to be used in securing the traffic is generated and distributed to peer PEPs in the network of PEPs. When an outbound packet having original source and destination addresses is received at the PEP, the PEP applies security processing to the outbound packet according to the security policy and forwards the secured packet in the network using the security protocol. The secured packet has at least a partially unsecured header portion indicating at least one of the original source and destination addresses.

When forwarding the packet, the packet may be routed through one of many possible data paths that are not known in advance of the forwarding of the packet. The particular data path for the packet may be determined using load balancing, quality of service, multicast, or broadcast routing techniques.

Generation of the outbound key may be performed by the PEP at initial key creation or at defined re-key intervals, or may be performed by a centralized key server from which the PEP receives the key. The outbound key may be distributed to peer PEPs by establishing a secure tunnel with a peer PEP and forwarding the key via the tunnel. In an alternative embodiment, the PEP may distribute the outbound key to peer PEPs by establishing a secure tunnel with a Key Authority Point (KAP). In this embodiment, the KAP authenticates a PEP as authorized to exchange keys, identifies peer PEP/KAPs based on the security policy, establishes secure tunnels with the peer PEP/KAPs, and distributes the outbound keys to the peer PEPs.

Determination of the security policy definition may include configuring the security policy definition to include addresses of a peer PEP and a KAP, and may occur when the PEP is configured or receives a packet for which no policy definition exists.

In one embodiment, one or more PEPs are associated with a Key Authority Point (KAP), and the network is configured to have at least two KAPs interconnected by a secure tunnel. In this embodiment, the outbound key is distributed by performing an Internet Key Exchange (IKE) negotiation between a first KAP and at least one other KAP using the secure tunnel, and distributing any keys received at the first KAP to at least one PEP associated with the first KAP.

In another embodiment, the PEPs may use shared keys to perform data decryption and encryption around firewalls, intrusion detection systems, SSL accelerators, and other devices that need to inspect decrypted packets, without burdening the network with multiple secure negotiations.

In yet another embodiment, the PEP is implemented in a network that services mobile wireless devices. This embodiment enables the same given key to be used for communication with a mobile device as the mobile device moves between wireless coverage areas and the mobile device's source address changes.

### BRIEF DESCRIPTION OF THE DRAWINGS

The foregoing and other objects, features, and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a system level diagram of a distributed key scenario using global key generation and global distribution between Key Authority Points (KAPs) and Policy Enforcement Points (PEPs).

FIG. 2 is a second scenario for key distribution, where keys are locally generated and locally distributed via a shared Policy Enforcement Point/Key Distribution Point (PEP/KAP) platform.

FIG. 3 is a third scenario where the outbound keys are locally generated, with global distribution on a shared PEP/KAP platform.

FIG. 4 is a fourth distribution scheme with group key generation and group KAP distribution.

FIG. 5 is a flow chart illustrating the steps performed in connection with the key distribution scheme of FIG. 1.

FIG. 6 is a flow chart illustrating how a PEP handles a distributed key.

FIG. 7 is a flow chart illustrating the steps performed in distributing outbound keys from a PEP/KAP to another PEP/KAP.

FIG. 8 is a flow chart illustrating how outbound keys are distributed from a PEP to another PEP via a KAP.

FIG. 9 is a flow chart illustrating how outbound keys are distributed from a KAP to another KAP and then to a PEP.

FIG. 10 is a diagram of an encrypted packet having the original source and destination address coupled to the outer header.

### DETAILED DESCRIPTION OF THE INVENTION

A description of preferred embodiments of the invention follows.

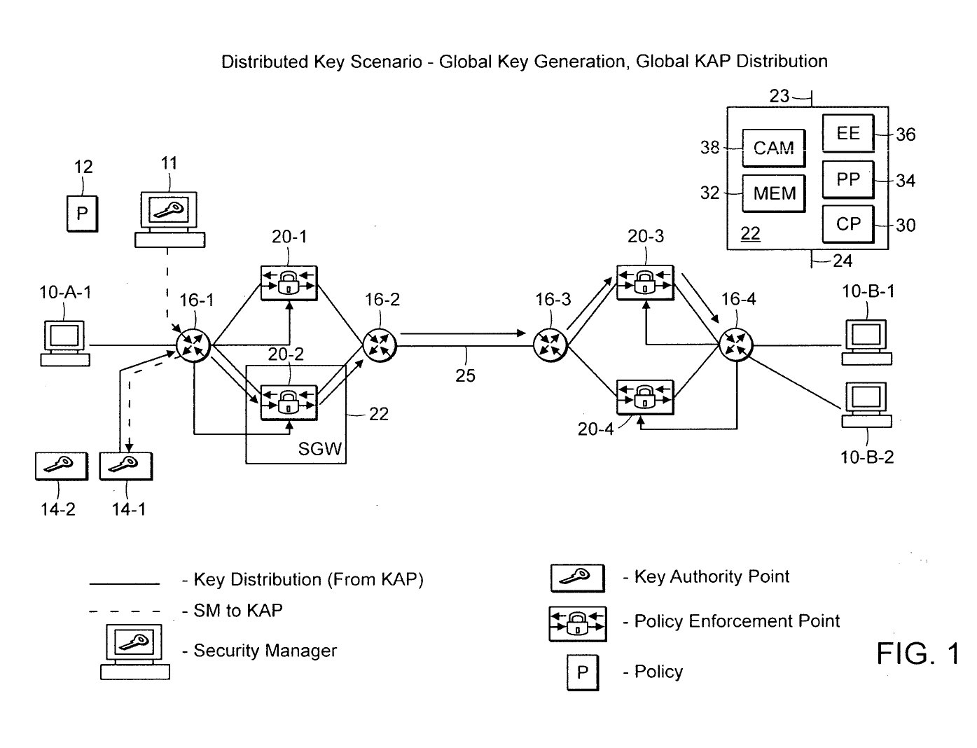

FIG. 1 is a system level diagram of a scheme for securing message traffic in a network in which a key is generated and then distributed through the network according to the invention.

The system generally includes a number of data processors and data processing functions including end nodes 10, a Management and Policy Server (MAP) 11, a Key Authority Point (KAP) 14, at least two inter-networking devices 16, such as routers/switches, and Secure Gateways (SGWs) 22. A secure tunnel connection 25 is maintained between at least two SGWs 22. The secure tunnel 25 can be provided by Secure Sockets Layer (SSL) and/or Transport Layer Security (TLS) or by a number of other known ways. Additionally, one or more of the SGWs 22 has an associated Policy Enforcement Point (PEP) function 20. It should be understood that other functions and devices may be present in the network and the above configuration is only one example.

The end nodes 10 may be typical client computers such as personal computers (PCs), workstations, Personal Digital Assistants (PDAs), digital mobile telephones, wireless network enabled devices and the like. The nodes 10 may also be file servers, video set top boxes, data processing machines, or other networkable device from which messages originate and to which message are sent. The message traffic typically takes the form of data packets in the well known Internet Protocol (IP) packet format. As is well known in the art, an IP packet may typically be encapsulated by other networking protocols such as Transmission Control Protocol (TCP), User Datagram Protocol (UDP), or other lower level and higher level networking protocols.

The Management and Policy Server (MAP) 11 is a data processing device, typically a PC or workstation, through which an administrative user may input and configure security policies 12. Additionally, the MAP 11 acts as a secure server to store and provide access to such policies by other elements of the system.

As will be described more fully below, the Key Authority Point (KAP) 14 and Policy Enforcement Points (PEPs) 20 cooperate to secure message traffic between the end nodes 10 according to the policies 12 stored in the MAP 11.

The KAP 14 is responsible for generating and distributing “secret data” known as encryption keys upon request. The keys are then used as a basis for deriving other keys that secure transmission of traffic from one end node 10 to another end node 10, perform authentication, and other functions.

The PEPs 20 are located on the data path, and are typically instantiated as a process running on a Secure Gateway (SGW) 22. The PEPs 20 have a packet traffic or “fast path” interface on which they receive and transmit packet traffic that they are responsible for handling. They also have a management interface over which they receive configuration information, and other information, such as policies 12 and encryption keys.

The PEPs are responsible for a number of tasks, principally for performing encryption of outbound packets and decryption of inbound packets received on the fast path interface. The PEPs 20 may thus identify packets that need to be secured according to configured policies 12. The PEPs 20 may also simply pass through or drop packets according to the policies 12.

The PEPs 20 also perform other tasks specific to the present invention, such as coding and decoding the address portion of the headers of the secured packets, as will be discussed below.

The PEP 20 is configured to perform IPsec tasks such as handling Security Association (SA) information as instructed by the MAP 11, to store and process Security Packet Index (SPI) data associated with the IPsec packets, and the like. The PEP 20 thus performs many if not all of the IPsec security gateway functions as specified in IPsec standards such as Internet Request for Comments (RFCs) 2401-2412.

The SGW 22, in which the PEP 20 runs, is configured to perform additional functions typical of IP network gateways, such as Network Address Translation (NAT), packet fragmentation handling, and the like.

According to the present invention, the MAP 11, the PEP 20, and the KAP 14 perform and/or participate in several additional specialized functions including:
copying original addresses to the outer headers of IPsec packets;
key generation
key distribution
policy generation
policy distribution (local and remote)
policy linkage

These functions are now discussed generally, before continuing with detailed examples of packet formatting, key generation, and key distribution according to the present invention.

Copying original source and destination addresses to the outer headers of IPsec packets—As is known in the art, a standard IPsec datagram in tunnel mode may be used to provide Virtual Private Networking (VPN) and other security functions. In standard IPsec tunnel mode processing, the entire content of an original source IP packet is encrypted and encapsulated inside another IPsec packet. The IPsec packet is sealed with an Integrity Check Value (ICV) to authenticate the sender and to prevent modification of the packet in transit.

Unlike standard IP packets or other types of IPsec packets (e.g., so-called transit mode packets), IPsec tunnel mode packets have their full original IP header, as well as the payload, encapsulated and encrypted. This allows the source and destination address of the packet to be different from those of the encompassed packet which, in turn, permits the formation of a secure tunnel through which to route the IPsec packet. When a tunnel mode packet arrives at its destination it goes through an authentication check, including validation of the special IPsec tunnel mode headers, and authentication of the packet, such as by performing a cryptographic hash such as MDS or SHA-1. Mismatched hash values are then used to identify the packet as either being damaged in transit or not having the proper key numbers. After the IPsec headers are validated, they are stripped off and the original IP packet is restored in the clear, including its original header with original source and destination addresses.

Most IPsec implementations treat the tunnel mode as a virtual network interface, just as an internet interface at a local node, and the traffic leaving it is subject to ordinary routing decisions thereafter. At this point, it has become a regular IP datagram once again, thus internetworking equipment that does not have access to the keys, or other SA data may still make routing decisions.

However, the IP addresses must be included in the integrity check value according to IPsec, thus any modification to them will cause the check to fail when verified by the recipient. Because ICV incorporates a secret key which is unknown by the intermediate parties, an intermediate router, such as one that may be used for load balancing and/or multicast, is not able to re-compute the ICV.

The same difficulty also applies to Port Address Translation (PAT) which maps multiple private IP addresses into a single external IP address. Not only are the IP addresses modified on the fly, but the UDP and TCP port numbers may also be modified.

Similar difficulties exist when routing IPsec packets that are not standard IP packets. As discussed above, IPsec does not support multicast, router peering for load balancing or resiliency, or other functions. Thus, standard IPsec processing is not compatible with several common network functions and thus is often limited to uses where the source and destination networks are reachable without packet address translation.

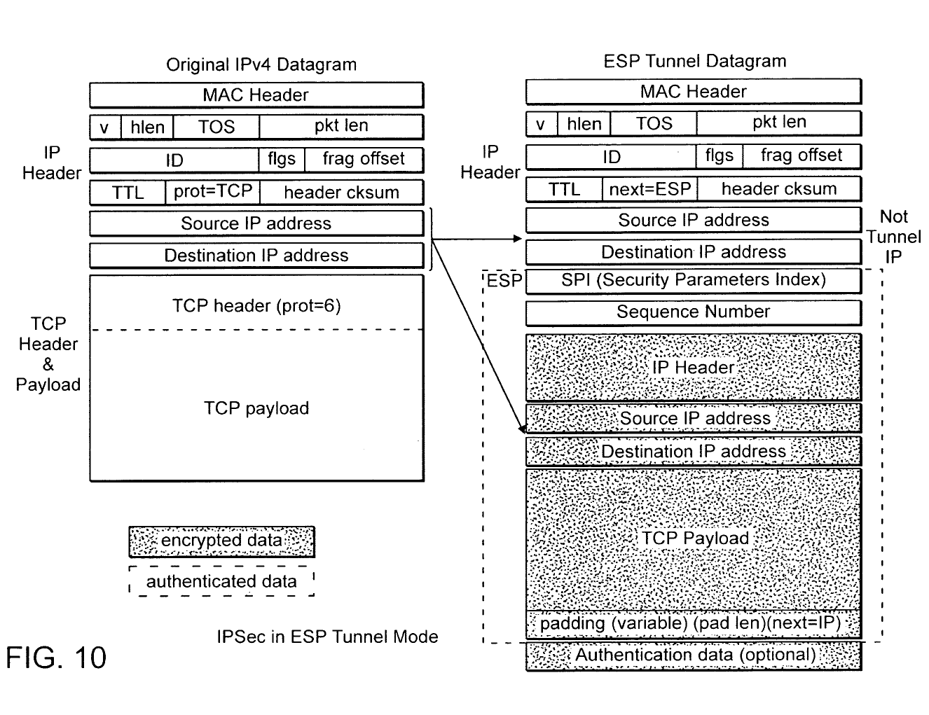

According to the present invention, the PEP 20 overcomes this difficulty by maintaining the IP header of outgoing packets in the IPsec outer header. FIG. 10 illustrates a typical outgoing packet created by the PEP 20 that exhibits this property. As can be seen, the original source and destination IP address, as well as the original source and destination MAC address, of the encrypted packet have been copied into the IPsec outer header. This provides greater flexibility in handling the encrypted packet in a number of situations that would not otherwise be possible with encrypted IPsec tunnel mode packets. For example, in a multicast or broadcast situation, the original source and destination address information is needed to properly handle the packet in the network, as it may travel through many locations and not just through paired point to point gateways. Without having copied the address information to the outer header, it would not be accessible to intermediate devices that do not have keys and thus could not decrypt the packet. In load sharing, resiliency, and other situations where more than one physical router might receive a packet, the packet may also travel down different paths and between different internetworking devices 16. Having the PEP copy the original source and destination address information permits routing of the resulting IPsec-like packet according to its original address, rather than exclusively according to its IPsec tunnel mode addresses.

Key Generation—This module creates keys to secure a given tunnel. As in IKE this is done in coordination with a single peer as each side agrees on outbound and inbound keys. However, in an embodiment of the present invention, this may also be a single unit that generates keys for traffic between a number of units, or it may be embodied in a single SGW generating a key for outbound traffic on a given tunnel.

Key Distribution—This module ensures that all connections to the tunnel have the keys necessary to decrypt and encrypt data between the end points. As mentioned previously, this is done in standard IKE as part of the IKE Phase 2 key exchange between two peers. However, in the present invention, as will be described in the following detailed examples, this is performed by the PEPs exchanging keys in other ways. With these techniques, key distribution is still securely protected to prevent eavesdropping, tampering, and to ensure that the exchange occurs with an authorized party.

As described below, the Key Generation and/or Key Distribution modules may be located on individual stand alone machines, or may be incorporated together within a Key Authority Point (KAP). In addition, Key Distribution may be co-located with the PEP 20 in other architectures.

Local Policy Definition (also called “Policy Generation” herein)—This module maintains information on IP addresses, subnets, ports, and or protocols protected by the SGW 22. This may be part of a complete policy definition 12 for many different nodes in the network as specified by the MAP 11. The policy definition 12 may also be limited to a collection of subnets protected by a certain SGW 22, or it may simply relate to and be stored at a single IP address, such as within the network software on a remote access client 10 (for example, Microsoft Windows and other operating systems provide certain tools for specifying security policies.) The policy definition 12 can also occur via a discovery process performed by an SGW 22. If a complete security policy definition 12 is not present, it should also include information to link the protected local traffic to its secure destinations. However, since the present invention is related to the distribution of keys, the exact manner of implementing all of the Policy Definition, Policy Linkage, and Policy Distribution modules is not critical, so long as the PEPs 20 and/or KAPs 14 have access to the policies 12.

In general, all traffic between the modules described above is either local (within a single device) or protected by a secure tunnel. Each device is managed via a secure tunnel and with a secure user authentication. Additionally, if highly resilient, implementation is required, each module must itself be resilient and if a state is stored, a method for exchanging state and performing switch-over must be implemented.

Details of Key Generation and Distribution

Using the above separation of functionalities, a number of different scenarios may be implemented to address the various limitations of standard IKE/IPsec. It should be noted that not all implementations may be performed at the same time, and each offers certain limitations or needs special requirements.

A. Global Key Generation, Global Key Distribution via KAPs

In a first scenario, illustrated in FIG. 1, key generation for each outbound flow is generated local to the PEP 20. The outbound key is, rather than being distributed over IKE tunnels, sent directly to a set of configured peers, or sent indirectly via a common KAP 14.

In this configuration, Policy Generation and Policy Distribution are implemented on a single unit such as a Management and Policy Server 11. The Management and Policy Server 11 is configured with a complete Policy Definition 12 for all nodes 10 that wish to communicate with one another. Thus the single MAP 11 contains both the Local Policy Definition and Remote Policy Definition modules. The MAP 11 also has an identification of the particular PEP units 20-1, 20-2 that are located local to MAP 11 as well as any PEP units 20-3, 20-4 that are located at the remote site(s) that it manages. The policy and network configuration data may be entered by an administrative user logged into the station MAP 11 and entering such information.

Each PEP 20 receives policy information from the MAP 11 and distributes any keys its receives from KAP 14-1. The MAP 11 is also responsible for ensuring that each PEP 20 is properly configured so that it may initiate re-key requests to KAP 14-1 for at least its outgoing keys. This configuration provides a robust response to load balancing and resiliency while offering ease of management in simple state functionality in each unit. The whole secure network state is thus distributed, and there is no single point of attack for an intruder.

As with load balance solutions this approach may make little, if any, use of IPsec sequence numbers and may be more open to certain replay attacks. Scalability is also good but limited by the number of SA entries required at each PEP 20 (each PEP 20 must produce a key for each given tunnel.) This approach could also be used for multicast, providing improved security but the management of keys could become prohibitive.

Creation of a new Policy 12 for a new connection causes the MAP 11 to request KAP 14-1 to generate a key. For example, a policy 12 may be created at MAP 11 specifying that transmissions from node A1 (client device 10-A-1) to node B2 (client device 10-B-1) need to be secured. The MAP 11 then requests the KAP 14-1 to generate a key to be used for the A1-outbound to B1-inbound (A1→B1) connection.

The generated key is then distributed to all of the PEPs 20 that could possibly handle traffic for the A1→B1 connection. In the preferred embodiment, the key for the A1→B1 connection is distributed from the KAP 14-1 to the PEPs 20-1, 20-2 for use as an outbound key. The key is also distributed from the KAP 14-1 to the PEPs 20-3, 20-4 for use as an inbound key. The key is preferably distributed through management interfaces on the PEPs 20 (typically not the fast path traffic interface) over a secure tunnel using IKE. While the secure tunnel is certainly used for transmission of the new key to the remote PEPs 20-3, 20-4, it may even be used for transmitting the key to the local PEPs 20-1, 20-2.

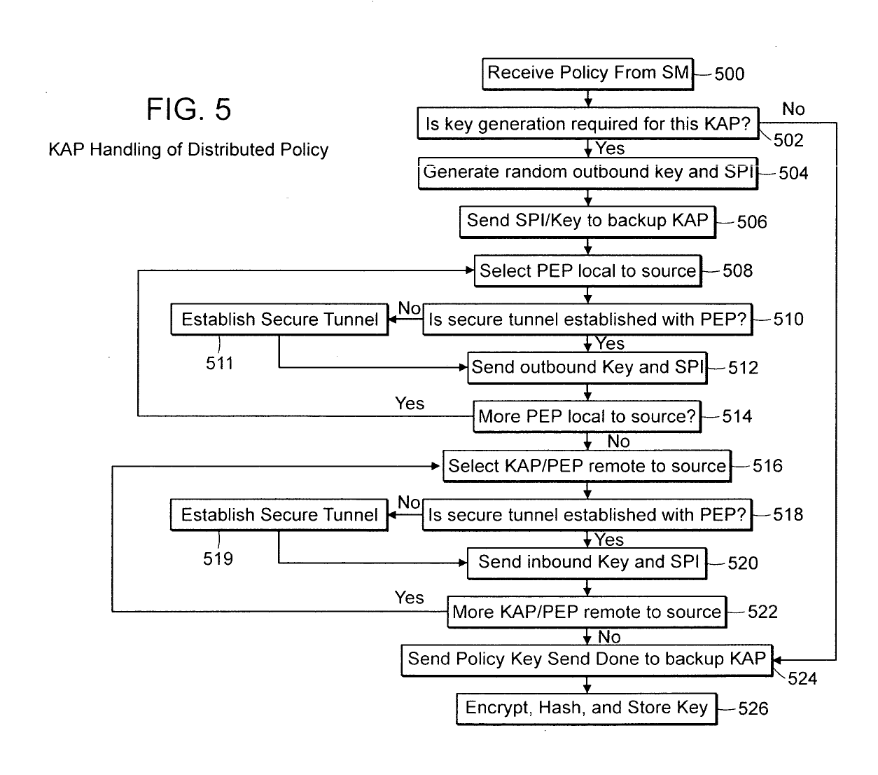

A detailed flow chart of this key distribution scheme is illustrated in FIG. 5. In step 500, the policy for the new A1→B1 connection is received by the KAP 14-1 from the MAP 11. In step 502 it is determined if a new key must be generated for this particular connection. If not, then processing may continue to step 524, where a message is returned to indicate that the key is already available.

However, if a new key needs to be generated, then in step 504 the KAP 14-1 generates a new random outbound key. It will typically also generate a new Security Packet Index (SPI) as may be needed if the policy specifies that the A1→B1 connection is to handle IPsec packets.

In the next step 506, the SPI and key may be distributed to a backup KAP 14-2 as part of key distribution. An associated backup KAP 14-2 may be local to the same network as the original KAP 14-1 or it may be remote. In either event the SPI and key are, again, sent via secure mechanism such as a secure tunnel.

The KAP 14-1 then checks a list of PEPs 20 for which it is responsible. Starting first with the PEPs 20-1, 20-2 that are local, in step 508, processing proceeds to step 510 where it is determined whether a secure tunnel is already established with the first PEP 20-1. If not, then the secure tunnel between the KAP 14-1 and the management interface on the PEP 20-1 is established in step 511. The secure tunnel is typically established using IKE or other protocols. Once the secure tunnel is set up, the outbound key and SPI are sent to the first local PEP 20-1 in step 512.

In step 514, it is then checked to see if there are additional PEPs local to the KAP 14-1 that may handle the A1→B1 connection. If so, then processing returns to repeat steps 508, 510, 511, and 512, until each of the PEPs 20-1, 20-2 that are local to the KAP 14-1 are fed the outbound key for the A1→B1 connection. Once the local PEPs 20-1, 20-2 are populated, the PEPs 20-3, 20-4 remote to the source are then selected in step 516.

In step 518, if a secure tunnel is not already established with the management interface on the first remote PEP 20-3 then the tunnel is established in step 519. As in step 511, this can be using standard secure tunneling techniques with the IKE protocol, however, other methods are possible, such as SSL/TLS, to establish a secure connection.

In step 520, the key and SPI are sent to the remote PEP 20-3 as an inbound key and SPI for the A1→B1 connection. Step 522 then checks whether there are additional PEPs remote from the KAP 14-1, and if so, they are also populated with the required inbound key. Once all PEPs 20 have been populated, a message is sent to the backup KAP 14-2 that configuration of the A1→B1 connection is complete in step 524. Finally, in step 526, the key is encrypted, hashed, and stored. Step 526 is performed in case of a breach of the security of the KAP 14-1 itself.

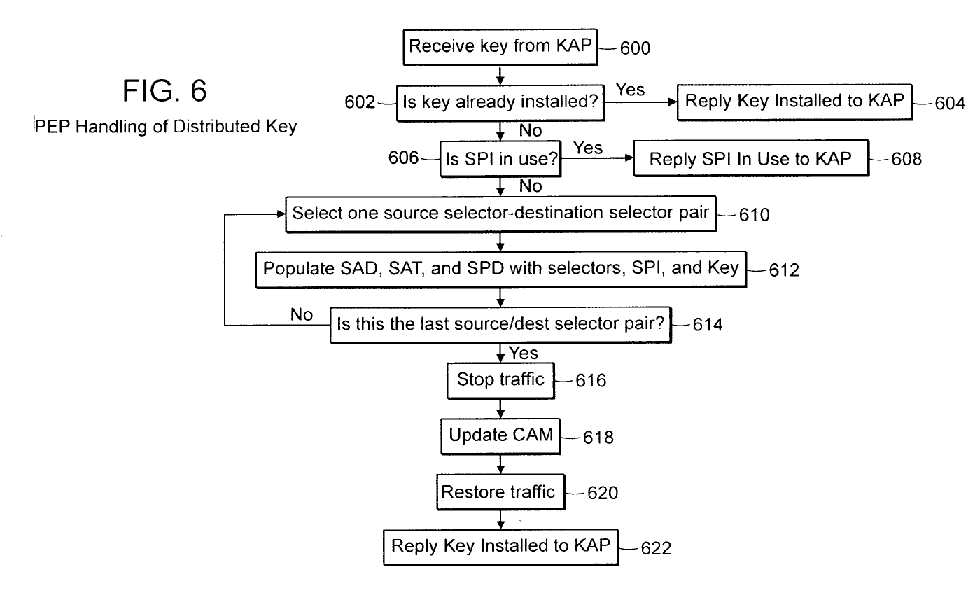

FIG. 6 is a flow diagram illustrating the steps performed by a PEP 20 when it receives a key distributed from the KAP 14-1. The first step 600 is entered when a key is received from the KAP 14-1. It should be noted that the key may have been received from a local KAP 14-1, such as the case when PEP 20-1 receives an outbound key from KAP 14-1. However, the key may also be received from a remote KAP 14-1 to be used as an inbound key, such as in the case of PEP 20-3.

A test is then performed in step 602 to determine whether a key is already installed, as a PEP 20 may receive the same key more than once. If the key is already installed, a reply message is sent in step 604 to the KAP 14-1 that the key is already installed.

If the key is not already installed, then a test is performed to determine whether the SPI is already in use for this specific A1→B1 connection in step 606, and if so, a message is sent in step 608 that the SPI is already in use.

If, however, the SPI is not already in use, then one source destination pair is first chosen in step 610. For example, a given PEP 20 may be responsible for protecting more than one connection. In the example above, only the securing of a one way connection between two nodes has been addressed, A1-outbound to B1-inbound. PEPs 20 may also, for example, be responsible for securing a second connection from A1 to B2. In this case, each possible source/destination key is processed.

In step 612, the SPI and key are populated through their respective Security Association Data (SAD), Security Association Table (SAT), and the Security Policy Data Structures (PDS); these include the Security Association Database (SAD) and Security Policy Database (SPD) in accordance with standard IPsec processing.

In step 614, a test is performed to determine whether there are any remaining source/destination pairs. If so, then step 610 and 612 are repeated for the next pair.

Once all possible source/destination pairs are processed, any existing traffic through the PEP 20 is stopped in step 616. In step 618 a local Content Addressable Memory (CAM) is updated. More particularly and referring to FIG. 1, a typical SGW 22 is a traffic handler that has a fast path interface 23 and a management path interface 24. The device 22 itself includes a control processor 30 with associated program memory 32 and a packet processor 34 that implement the PEP 20. The packet processor may itself be specifically programmed for handling received packets and may use special machines, such as an encryption engine 36, that rapidly encrypts and decrypts packets. However, in order to further expedite its handling of packets, the packet processor may make use of a Content Addressable Memory 38 which it uses to perform fast lookup of the security associations based on the source and destination of packet headers. The CAM lookup result informs the packet processor 34 of the information it needs to perform encryption and authentication before routing the packet on the fast path interface, such as a forwarding port and address. Returning to FIG. 6, in step 620, the traffic is restored, and in step 622, a reply that the key is installed is sent to the KAP 14-1.

B. Outbound Keys, Local Distribution

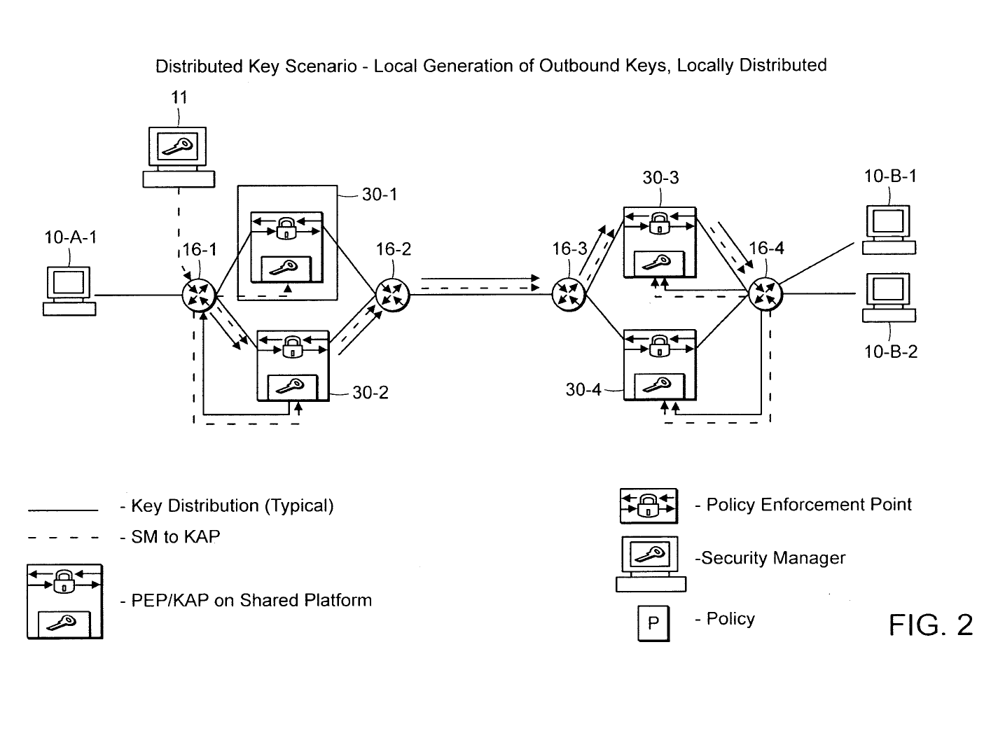

FIG. 2 shows a key distribution scenario where outbound keys are generated locally and only distributed locally. In this process, a PEP 20 and a KAP 14 may be located on a shared hardware platform 30, located in a SGW 22 as in the previous example discussed in FIG. 1. A Management and Policy Server 11 is again present, and as with the previous example, Policies 12 specify the traffic flowing from node A1 to B1 (A1→B1) and from node A1 to B2 (A1→B2) that needs to be secured.

The PEP 20 and KAP 14 perform the same function as discussed above, however, they are resident on the same physical platform. Generating and distributing the keys from the same point provides additional security as compared to the previous example of FIG. 1. As with the FIG. 1 architecture, this arrangement also provides no one place where an intruder may break into and obtain access to the keys as no one platform performs the Key Generation and Key Distribution functions for the whole network.

This architecture also has an advantage in that it permits the possibility of generating keys dynamically. Thus when traffic is first received at a PEP/KAP 30 the existence of the new connection may be recognized and the keys generated at that point. This configuration also provides certain advantages over a standard IKE point to point configuration for key distribution.

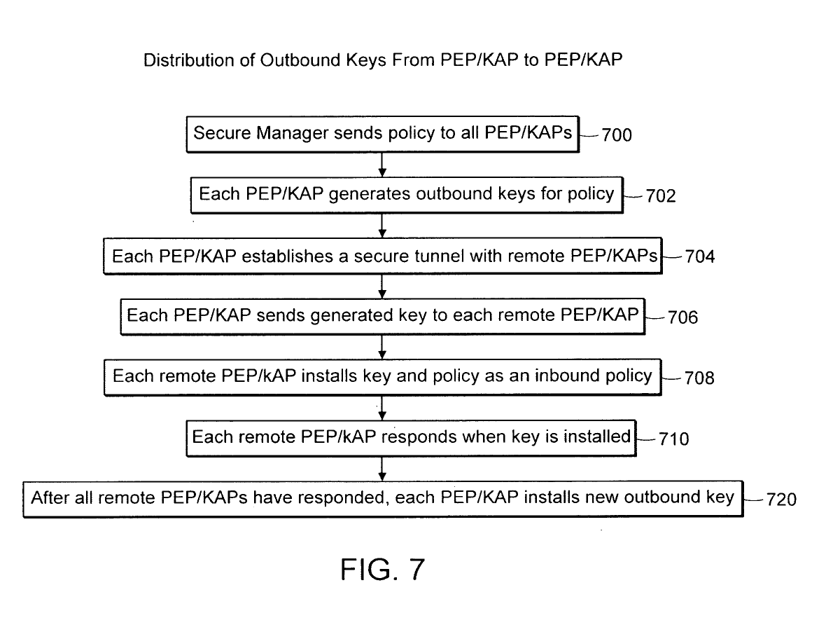

Processing in this configuration proceeds as in FIG. 7. In the first step 700, the MAP 11 sends its policies to all PEP/KAPs 30 in a manner similar to that described in connection with FIG. 5. Each PEP/KAP 30 then generates respective outbound keys for the connections for which it is responsible, according to the policy in step 702. This can be done at the request of and in response to the Management and Policy Server 11 reporting a new configured connection, or can be done in response to an “on the fly” request as a new packet is received.

In step 704, each PEP/KAP 30 establishes a secure tunnel with its respective remote PEP/KAP with which it expects to communicate. Thus, in this example, PEP/KAP 30-1 will first establish a secure tunnel with remote PEP/KAP 30-3 with which it must exchange a key to support communication on connection path A1→B1.

In step 706 the local PEP/KAP 30-1 sends its generated key to the remote PEP/KAP 30-3 using the available secure key exchange mechanisms.

In step 708, the remote PEP/KAP 30-3 installs a received key and policy as an inbound policy. Thus, in the described example, the key generated at PEP/KAP 30-1 will be stored as an outbound policy for connection A1→B1 at PEP/KAP 30-1, and will be stored as an inbound policy for connection A1→B1 at PEP/KAP 30-3. The remote PEP/KAP 30-3 then responds when it has installed the key at step 710.

This process continues until all remote PEP/KAPs 30 have responded and each PEP/KAP 30 reporting that it has installed its new outbound key at step 720. In the illustrated examples, this will occur after PEP/KAP 30-4 reports that its new outbound key has been installed for the connection A1→B1.

C. Local Generation of Outbound Keys, Global KAP Distribution

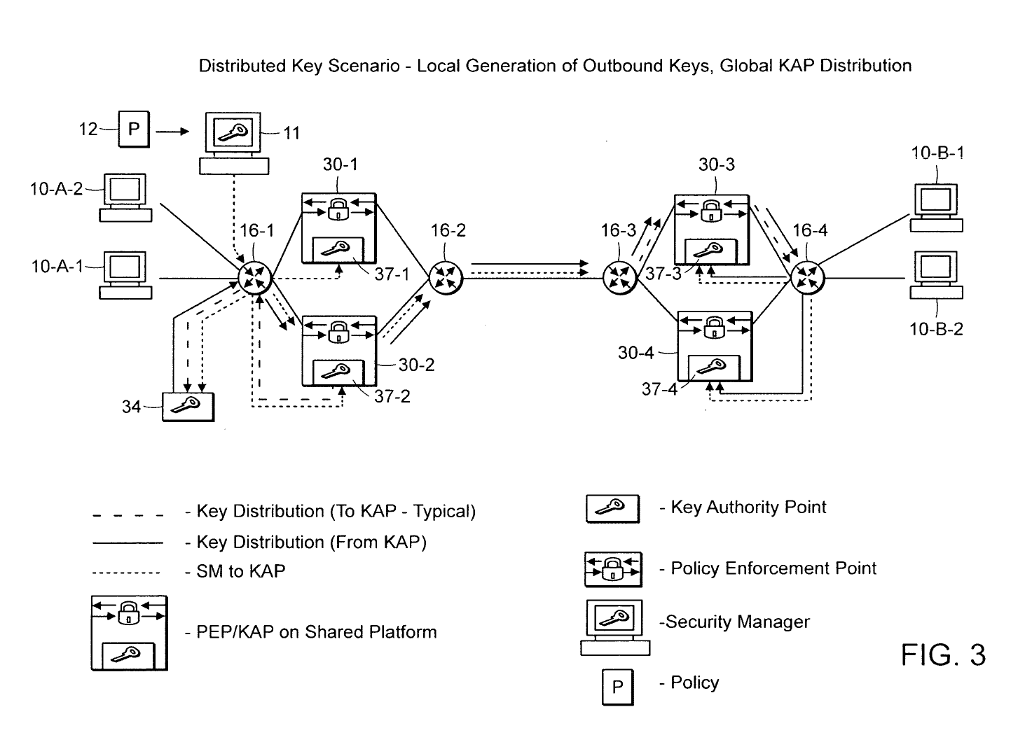

Locally generated keys can also be used for outbound connections with global distribution by KAPs as shown in FIG. 3. In this case all keys are generated in one KAP 34, similar to the scenario in FIG. 1. However, responsibility for distributing keys is located in another location. In this example, the key distribution functions (KAPs 37) are located on the same platform as the PEPs 30.

This configuration provides a way to reduce the number of tunnels needed as compared to FIG. 2, and also makes it easier to recover from a failed PEP/KAP 30.

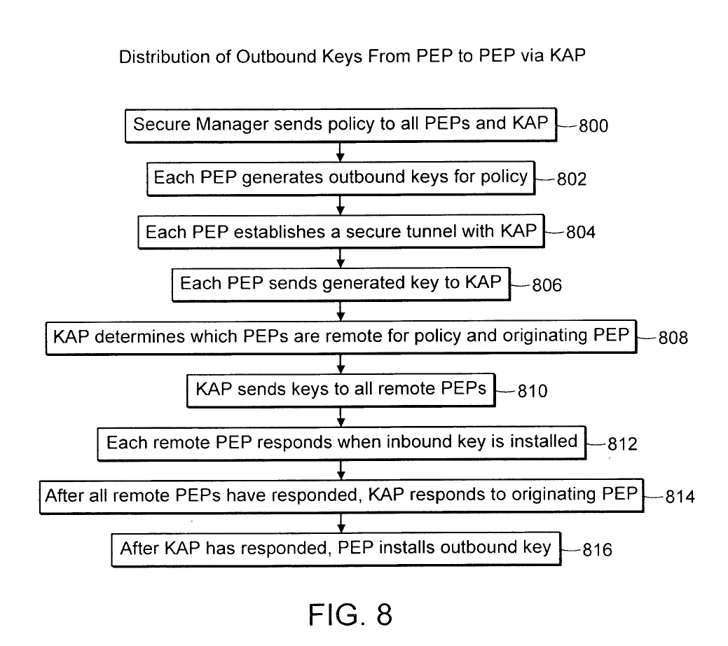

As illustrated in FIG. 8, in a first step 800 the Management and Policy Server 11 sends its policies to all PEPs 30 and the KAP 34. In the next step 802 each PEP 30 generates its outbound keys according to the policy for the newly configured connection A1→B1. In step 804, each PEP 30 then establishes a secure tunnel with the KAP 34. Note that access to the KAP 34 may require a local connection as in the case of PEP 30-1 and PEP 30-2 or may require a remote connection, as in the case of PEP 30-3 and PEP 30-4.

In step 806 each PEP 30 then sends the generated key to its associated KAP 37 (on the same platform.) In step 808, the KAP 37 determines which PEPs are remote as specified by the policy 12, and the originating PEP. In the illustrated example, KAP 37-1 will determine that PEP 30-1 is the originating PEP for the connection A1→B1, however, it will also determine that PEPs 30-3 and 30-4 need to have the generated key for use as an inbound key. The KAP 37-1 then sends the key to the all of the identified possible remote PEPs in step 810.

Step 812 is entered when each remote PEP 30-3, 30-4 reports acknowledge that its new inbound key is installed. In step 814, after all remote PEPs have responded, the KAP 37-1 can respond to the originating PEP 30-1 that its keys have been distributed and that setup has now been completed at the remote end. It should be noted that PEP 30-1 is not needed to establish multiple secure tunnels with a remote end, or even know the configuration information, and that the responsibility is retained with the KAP 37-1 function itself. After the KAP 37-1 has responded, the PEP 30-1 may install its outbound key in step 816, enabling a secure connection for traffic on connection A1→B1.

As in the previous example, it should be noted that the policy may specify that multiple connections be supported over the same secure paths, i.e., a single tunnel connection may also be used to support connections A1→B2 and A2→B1, as well as other possible connections.

D. Group Key Generation, Group KAP Distribution

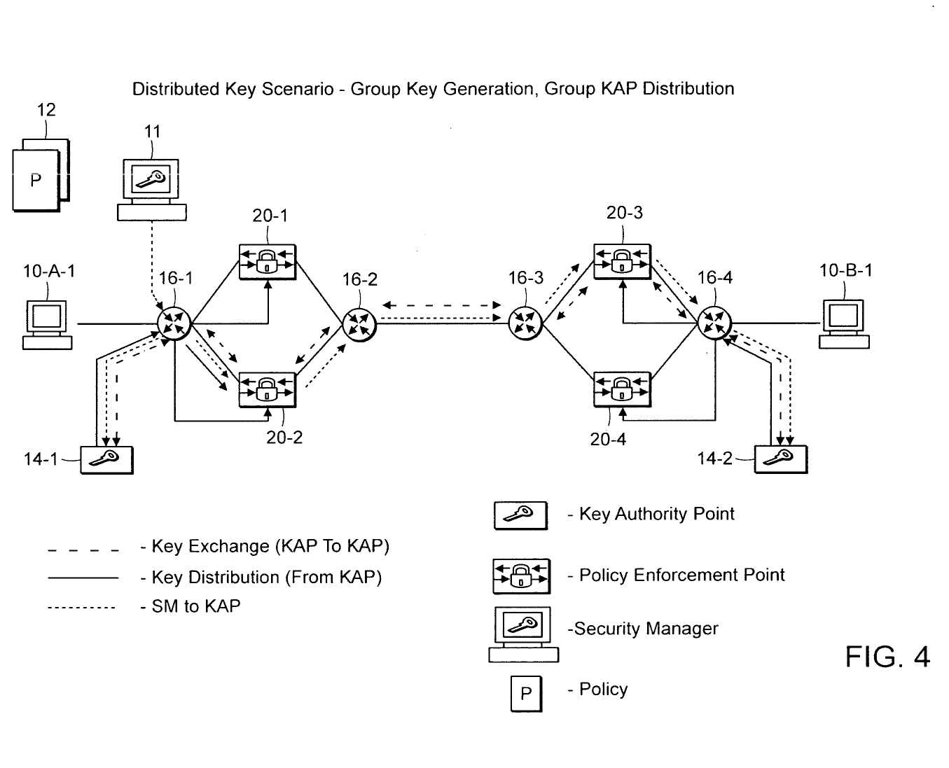

FIG. 4 illustrates another key distribution scenario. Here the physical division of functions is similar to that of FIG. 1, but Key Distribution is distributed to different locations in the network, to support group level key generation and group level key distribution. This permits the PEPs 20 to be limited to exchanging keys and distributing them locally, freeing them from having to distribute keys remotely. The advantage of this approach is that it reduces network traffic even further.

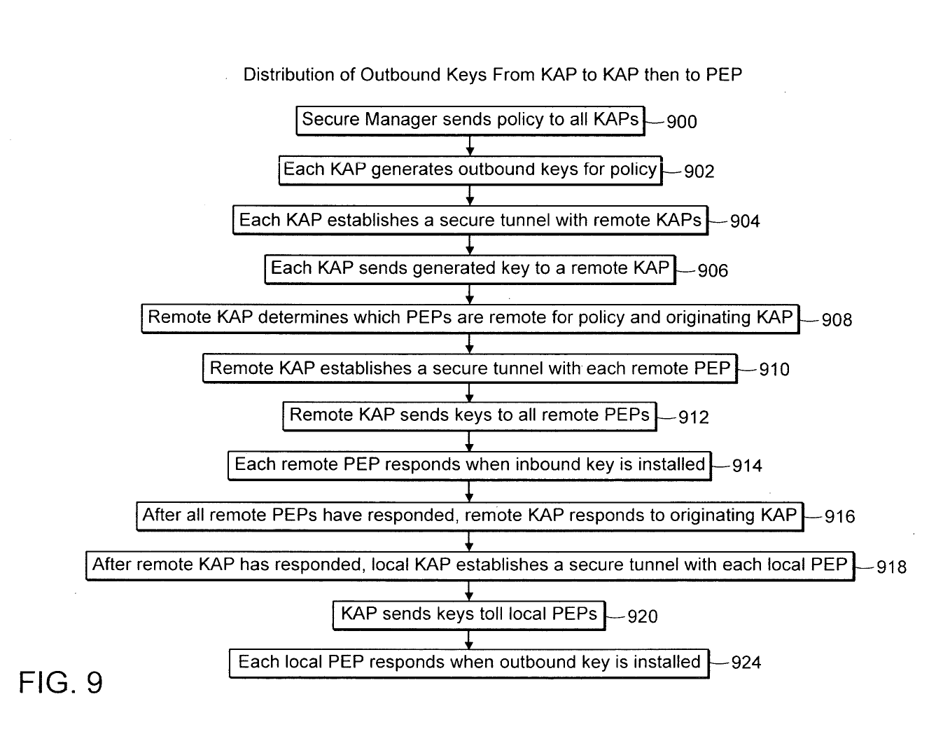

Referring to FIG. 9, the Management and Policy Server 11 first sends a policy to all KAPs 14 including local KAP 14-1 and remote KAP 14-2 in step 900. In step 902, each KAP 14 generates outbound keys according to the policy.

Each KAP 14 then establishes a secure tunnel with its associated remote KAPs in step 904. As an example, if KAP 14-1 has been requested by Management and Policy Server 11 to configure a policy for connection A1→B1, KAP 14-1 will then establish a secure tunnel with remote KAP 14-2. The key generated for connection A1→B1 will then be sent to the remote KAP 14-2 in step 906.

In step 908 the remote KAP 14-2 determines which remote PEPs are associated with the A1→B1 policy and the originating KAP 14-1. Thus, KAP 14-2 will check to determine that its PEPs 20-3, 20-4 are remote to the policy being established for the connection A1→B1.

The remote KAP 14-2 then establishes a secure tunnel with its local PEPs 20-3, 20-4 (the PEPs that are remote for the configuration being established) in step 910 and then sends the inbound key to them in step 912. Each remote PEP 20-3, 20-4 then responds when its inbound key has been installed in step 914. In step 916, after all of the remote PEPs 20-3, 20-4 have responded to KAP 14-2, the remote KAP 14-2 may then respond to the originating KAP 14-1 that its task of distributing the key is complete.

In step 918, after the remote KAP 14-2 has responded, the originating KAP 14-1 establishes a secure tunnel with each local PEP 20-1, 20-2. KAP 14-1 then sends the key to all local PEPs 20-1, 20-2 in step 920. Each local PEP then responds when its outbound key is installed in step 924. The KAP 14-1 may then, having installed all the keys, report back that secure communication can now occur on connection A1→B1.

A decision to encrypt may be based on source and destination address values, which may be an IP address or may be a subnet addresses. The problem is that one needs a policy for every node and every possible combination of nodes. For example, in a scenario where there are two nodes on the left hand side A1, A2 and three nodes on the right hand side B1, B2, B3 a policy must be configured for the six possible connections A1 to B1, A1 to B2, A1 to B3, A2 to B1, A2 to B2, and A2 to B3. With multicast traffic, each node is required to obtain the same key. Thus for example, if A1 is to be able to multicast to node B1, B2, and B3, each node B1, B2, and B3 must obtain the same key for decrypting its inbound traffic. In the configuration of FIG. 4, each PEP may obtain its own outbound key, but there must also be a mechanism for distributing keys so that they may be used on inbound traffic as well. The approach of FIG. 4 and the method of FIG. 9 provide one solution to this situation, since a single key may be associated with more than one connection.

Although the above examples assure that one key is used for each node-to-node connection, keys may also be generated on a per PEP basis. Thus for example, a PEP may serve as a proxy for the nodes that it serves. In this case, the key would be associated with the particular individual PEP.

An advantage of the configuration such as that shown in FIG. 2 is that if the keys of node B1 are compromised, then the connection from A1 to B2 may still be considered to be secure. Another advantage is provided by the fact that if one wants to remove B2 as an authorized communicator on the network, one may simply populate a request to all PEPs to destroy B2's keys, without necessarily having to re-key all the other end nodes.

In this manner the invention provides advantages over prior art scenarios such that key distribution is managed in a sensible fashion and over secure tunnels while at the same time supporting communication and methods such as multicasting, load balancing, and resiliency. This is important in medium and large sized network installations where hundreds, if not thousands, of computers share network gateways. It is also important in supporting future networking protocols such as multicast and broadcast packet traffic.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for securing message traffic in a data network using a security protocol, the method comprising the steps of:
at a policy enforcement point (PEP) within a network of PEPS, determining a security policy definition to be applied to the
traffic across the network, the policy definition including at least a definition of the traffic to be secured and parameters to be applied to the secured traffic;
generating an outbound key to be used in securing the traffic;
distributing the outbound key to peer PEPs in the network of PEPs;
receiving an outbound packet, the outbound packet having original source and destination addresses;
applying security processing to the outbound packet according to the security policy; and
forwarding the secured packet in the network using the security protocol, the secured packet having at least a partially unsecured header portion indicating at least one of the original source and destination addresses.

2. The method of claim 1, wherein in the step of forwarding the packet includes routing the packet through one of many possible data paths that are not known in advance of the step of forwarding the packet.

3. The method of claim 2, wherein the data path for the packet is determined using load balancing, quality of service, multicast, or broadcast routing techniques.

4. The method of claim 1, wherein the step of generating an outbound key is performed at initial key creation or at defined re-key intervals.

5. The method of claim 1, wherein the step of distributing the outbound key to peer PEPs further comprises the steps of:
establishing a secure tunnel with a peer PEP; and
forwarding the outbound key to the peer PEP via the secure tunnel.

6. The method of claim 1, wherein the step of distributing the outbound key to peer PEPs further comprises:
establishing a secure tunnel with a key authority point (KAP), and at the KAP, further performing the steps of:
(i) authenticating a PEP as authorized to exchange keys;
(ii) identifying peer PEP/KAPs based on the security policy;
(iii) establishing secure tunnels with the peer PEP/KAPs; and
(iv) distributing the outbound keys to the peer PEPs.

7. The method of claim 6, wherein the step of determining a security policy definition includes configuring the security policy definition to include addresses of a peer PEP and a KAP.

8. The method of claim 1, wherein the step of determining a security policy definition includes configuring the security policy definition to include addresses of a peer PEP.

9. The method of claim 1, wherein the step of determining a security policy definition occurs when the PEP (a) is configured, or (b) receives a packet for which no policy definition exists.

10. The method of claim 1, wherein the step of generating an outbound key is performed at a centralized key server, and the method further comprises the step of:
at the PEP, receiving the key from the centralized key server.

11. The method of claim 1, wherein one or more PEPs are associated with a key authority point (KAP), and the network is configured to have at least two KAPs interconnected by a secure tunnel, and the step of distributing the outbound key further comprises:
at a selected KAP, performing an Internet Key Exchange (IKE) negotiation between the selected KAP and at least one other KAP using the secure tunnel; and
at the selected KAP, distributing any received keys to at least one PEP associated with the selected KAP.

12. The method of claim 1, wherein the PEPs use shared keys to perform data decryption and encryption around firewalls, intrusion detection systems, SSL accelerators, and other devices that need to inspect decrypted packets without burdening the network with multiple secure negotiations.

13. The method of claim 1, wherein the PEP is implemented in a network that services mobile wireless devices, and the method further comprises the step of:
enabling the same given key to be used for communication with a mobile device as the mobile device moves between wireless coverage areas and the mobile device's source address changes.

14. A policy enforcement point (PEP) within a network of PEPs, the PEP comprising:
a security policy definition to be applied to the traffic across the network, the policy definition including at least a definition of the traffic to be secured and parameters to be applied to the secured traffic;
an outbound key to be used in securing the traffic, the outbound key being distributed to peer PEPs in the network of PEPs;
means for receiving an outbound packet, the outbound packet having original source and destination addresses;
means for applying security processing to the outbound packet according to the security policy; and
means for forwarding the secured packet in the network using the security protocol, the secured packet having at least a partially unsecured header portion indicating at least one of the original source and destination addresses.

15. The policy enforcement point of claim 14, wherein forwarding the packet includes routing the packet through one of many possible data paths that are not known in advance of forwarding the packet.

16. The policy enforcement point of claim 15, wherein the data path for the packet is determined using load balancing, quality of service, multicast, or broadcast routing techniques.

17. The policy enforcement point of claim 14, wherein the outbound key is generated at initial key creation or at defined re-key intervals.

18. The policy enforcement point of claim 14, wherein the PEP distributes the outbound key to peer PEPs via a secure tunnel.

19. The policy enforcement point of claim 14, wherein the PEP distributes the outbound key to peer PEPs via a secure tunnel with a key authority point (KAP), the KAP:
(i) authenticating a PEP as authorized to exchange keys;
(ii) identifying peer PEP/KAPs based on the security policy;
(iii) establishing secure tunnels with the peer PEP/KAPs; and
(iv) distributing the outbound keys to the peer PEPs.

20. The policy enforcement point of claim 19, wherein the security policy definition includes addresses of a peer PEP and a KAP.

21. The policy enforcement point of claim 14, wherein the security policy definition includes addresses of a peer PEP.

22. The policy enforcement point of claim 14, wherein the security policy definition is determined when the PEP (a) is configured, or (b) receives a packet for which no policy definition exists.

23. The policy enforcement point of claim 14, wherein the outbound key is generated at a centralized key server, and the PEP receives the key from the centralized key server.

24. The policy enforcement point of claim 14, wherein
the PEP is associated with a key authority point (KAP), the KAP being connected to at least one other KAP by a secure tunnel and distributing the outbound key to at least one associated PEP by performing an Internet Key Exchange (IKE) negotiation with at least one other KAP using the secure tunnel.

25. The policy enforcement point of claim 14, wherein the PEP uses shared keys to perform data decryption and encryption around firewalls, intrusion detection systems, SSL accelerators, and other devices that need to inspect decrypted packets without burdening the network with multiple secure negotiations.

26. The policy enforcement point of claim 14, wherein the PEP is implemented in a network that services mobile wireless devices and uses the same given key for communication with a mobile device as the mobile device moves between wireless coverage areas and the mobile device's source address changes.

27. A computer readable medium having computer readable program codes embodied therein for securing message traffic in a data network using a security protocol at a policy enforcement point (PEP) within a network of PEPs, the computer readable medium program codes performing functions comprising:
a routine for determining a security policy definition to be applied to the traffic across the network, the policy definition including at least a definition of the traffic to be secured and parameters to be applied to the secured traffic;
a routine for generating an outbound key to be used in securing the traffic;
a routine for distributing the outbound key to peer PEPs in the network of PEPs;
a routine for receiving an outbound packet, the outbound packet having original source and destination addresses;
a routine for applying security processing to the outbound packet according to the security policy; and
a routine for forwarding the secured packet in the network using the security protocol, the secured packet having at least a partially unsecured header portion indicating at least one of the original source and destination addresses.
